(19) United States
(12) Patent Application Publication
(10) Pub. No.: US 2008/0052108 A1
(43) Pub. Date: Feb. 28, 2008

(54) System and Method for Activating a Communication Device at a Point of Sale

(75) Inventors: Merrill Brooks Smith, Atlanta, GA (US); Phillip C. Graves, Atlanta, GA (US)

Correspondence Address: HUNTON & WILLIAMS LLP;INTELLECTUAL PROPERTY DEPARTMENT, RIVERFRONT PLAZA, EAST TOWER, 951 EAST BYRD ST., RICHMOND, VA, 23219-4074, US

(73) Assignee: e2interactive, Inc. d/b/a e2Interactive, Inc., Atlanta, GA (US)

(21) Appl. No.: 11/930,567

(22) Filed: Oct. 31, 2007

Related U.S. Application Data
(63) Continuation-in-part of application No. 10/778,338, filed on Feb. 17, 2004.
(60) Provisional application No. 60/519,629, filed on Nov. 14, 2003.

(51) Int. Cl. G06Q 10/00

(52) U.S. Cl. 705/1

(57) ABSTRACT

Methods of activating a communication device are disclosed. These methods may comprise receiving at a central processor an authorization request from a merchant terminal at the merchant store to authorize activation of a communication device, the central processor being in selective communication with the merchant terminal and a communications service provider; determining at the central processor whether the communication device was validly sold from the merchant store in a purchase transaction; authorizing at the central processor activation of the communication device, responsive to a determination that the communication device was validly sold from the merchant store in a purchase transaction; informing the communications service provider that the communication device is authorized and ready for activation; receiving at the central processor an activation notification from the communications service provider; and sending an activation notification message to the communication device.

### CROSS-REFERENCE TO RELATED APPLICATIONS

This application is a continuation-in-part of, and claims priority to U.S. patent application Ser. No. 10/778,338 filed on Feb. 17, 2004, which in turn claims priority to U.S. Provisional Application No. 60/519,629 filed Nov. 14, 2003.

### FIELD OF THE INVENTION

This invention relates to distributing and activating communication devices, such as wireless phones. More particularly, the invention relates to distributing wireless communication devices at point-of-sale merchant terminals wherein the communication devices may be used for wireless communication service.

### BACKGROUND OF THE INVENTION

Merchant stores receive wireless phones from distributors and sell the phones and other communication devices to customers. These phones may be pay-as-you-go wireless phones. Typically, the phones are inactive when the stores receive the phones from distributors. Thus, in order for a customer to use a phone after purchase, the phone must be activated through a communication service provider, i.e., a carrier. For instance, a customer may purchase at a merchant store a phone pre-associated with a specific wireless telecommunication provider. To activate the phone, the customer must later call the provider, at which point the provider determines whether to activate the phone. Typically, providers will automatically activate any phone at a customer's request. Once activated, the phone can be used for its intended purpose, such as wireless communication service.

The traditional method does not allow the carrier to know the status of the phone prior to activation. In other words, at the time of activation, but not prior, the carrier will know that the phone is in the hands of a user and no longer in the chain of distribution. However, the carrier will not know whether the phone was ever legitimately purchased at an authorized retailer. For instance, the carrier will not know whether the person calling to activate the phone is requesting to activate a stolen phone or a legitimately purchased phone.

What is desired is a method of distributing the phone to customers so that a carrier can verify that a phone was validly purchased prior to activation, and the phone can be activated without further action from the customer.

### SUMMARY OF THE INVENTION

Methods of activating a communication device are disclosed. These methods may comprise receiving at a central processor an authorization request from a merchant terminal at the merchant store to authorize activation of a communication device, the central processor being in selective communication with the merchant terminal and a communications service provider; determining at the central processor whether the communication device was validly sold from the merchant store in a purchase transaction; authorizing at the central processor activation of the communication device, responsive to a determination that the communication device was validly sold from the merchant store in a purchase transaction; informing the communications service provider that the communication device is authorized and ready for activation; receiving at the central processor an activation notification from the communications service provider; and sending an activation notification message to the communication device.

### DESCRIPTION OF THE DRAWINGS

FIG. 1 illustrates a system for authorizing the activation of a communication device according to an embodiment of the invention.

FIG. 2 illustrates an exemplary communication device and package.

FIG. 3 illustrates a flowchart showing a method of distributing a communication device according to an embodiment of the invention.

FIG. 4 illustrates a flowchart showing a method of authorizing the activation of a communication device according to another embodiment of the invention.

FIG. 5 illustrates a flowchart showing a method of authorizing the activation of a communication device according to yet another embodiment of the invention.

FIG. 6 illustrates a flowchart showing a method of distributing a communication device in accordance with some embodiments of the invention.

FIG. 7 illustrates a flowchart showing a method of authorizing the activation of a communication device in accordance with some embodiments of the invention.

FIG. 8 illustrates a flowchart showing a method of authorizing the activation of a communication device in accordance with some embodiments of the invention.

### DETAILED DESCRIPTION OF THE EMBODIMENTS

The subject matter of this application is related to the technology described in the following U.S. Patents and Patent Applications: U.S. application Ser. No. 10/253,243 filed Sep. 24, 2002, U.S. Provisional Application No. 60/324,333 filed Sep. 24, 2001, U.S. Provisional Application No. 60/396,404 filed Jul. 15, 2002, U.S. Provisional Application No. 60/519,630 filed on Nov. 14, 2003, U.S. Provisional Application No. 60/519,629 filed on Nov. 14, 2003, U.S. application Ser. No. 10/712,182 filed Nov. 13, 2003, U.S. application Ser. No. 10/655,828 filed Sep. 5, 2003, U.S. patent application Ser. No. 10/698,084 filed Nov. 3, 2003, U.S. application Ser. No. 10/411,971 filed Apr. 11, 2003, U.S. application Ser. No. 09/641,363 filed Aug. 18, 2000 (now issued as U.S. Pat. No. 6,575,361), U.S. Provisional Application No. 60/149,740 filed Aug. 19, 1999, U.S. application Ser. No. 10/732,641 filed Dec. 10, 2003, the U.S. Application filed Dec. 19, 2003 under Attorney Docket No. 64243.000005, and the U.S. Patent Application filed Jan. 16, 2004 under Attorney Docket No. 64243.000006. All of these applications are incorporated herein by reference in their entirety. It should be appreciated that the authorization and activation of communication devices as described herein may be combined with the novel systems and methods of the applications referenced above.

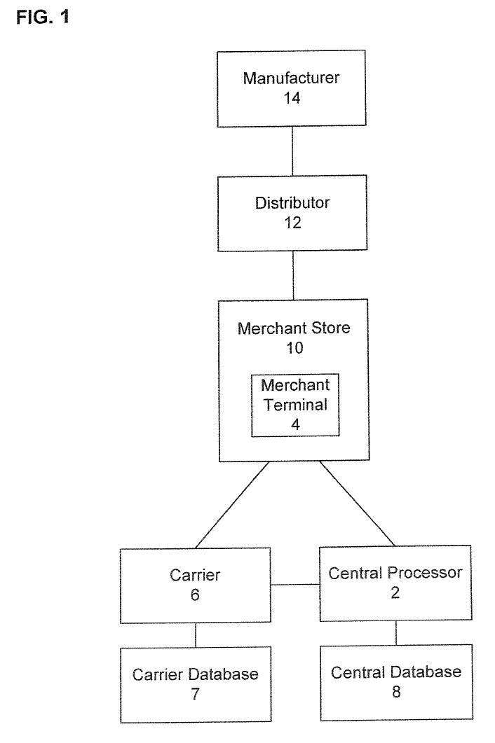

FIG. 1 illustrates a system for authorizing the activation of a communication device according to an embodiment of the invention. The system comprises a manufacturer 14, distributor 12, one or more merchants 10, one or more merchant terminals 4, a central processor 2, a central database 8, a communication service provider 6 (also called “carrier” herein), and a carrier database 7.

The communication device may comprise a wireless handset such as a wireless phone, PDA, pager, phone/PDA combination device, internet-enabled device, or any other communication device. The communication device may be in a package, for instance when it is sold. The communication device package may be any container, box, or packaging that may contain, hold, or otherwise couple to the device. In a preferred embodiment, the package contains the device 16 when the customer purchases the device at a merchant terminal 4.

The manufacturer 14 manufactures communication devices and passes them to one or more distributors 12. The distributors 12 ship the communication devices to one or more merchant stores 10. The merchant stores 10 comprise one or more merchant terminals 4. Customers purchase the communication devices at merchant terminals 4.

The merchant terminals 4 comprise an input/output device for inputting communication device and/or package information (such as an identifier) during a purchase transaction and passing such information to the central processor 2. For instance, the merchant terminals may comprise any point-of-sale terminal configured to process sale transactions between merchants and customers. The merchant terminal 4 may comprise a barcode scanner and credit card reader, and it may be in selective communication with a network as well-known in the art.

The central processor 2 may comprise any data processing system that stores, manages, and/or processes device-related information. In one embodiment, the central processor 2 may itself be a communication service provider 6 (also called a “telecommunications carrier” or “carrier” herein). The central processor 2 is configured to process device-related information (such as an identifier). The central processor 2 is further configured to store device-related information in a central database 8. The information may comprise information received from a merchant terminal 4 during a device sale transaction. The central processor 2 is also configured to communicate information to and from a carrier 6. For instance, the central processor 2 is configured to receive authorization requests and/or status inquiries from carriers 6. The central processor 2 is configured to process information stored in the central database 8 based on such requests and inquiries. The central processor 2 is also configured to pass information to the carrier.

In one embodiment, the central processor 2 is configured to communicate with merchant terminals regarding device activation requests.

The carrier 6 may process information it receives from the central processor 2. The carrier may also store information in a carrier database 7. The carrier 6 is also configured to communicate with customers. For instance, the carrier 6 is configured to receive device activation requests from customers. The carrier 6 is also configured to process information based on the request and/or communicate with the central processor based on the request. The carrier 6 is also configured to pass information to the customer, such as an activation confirmation.

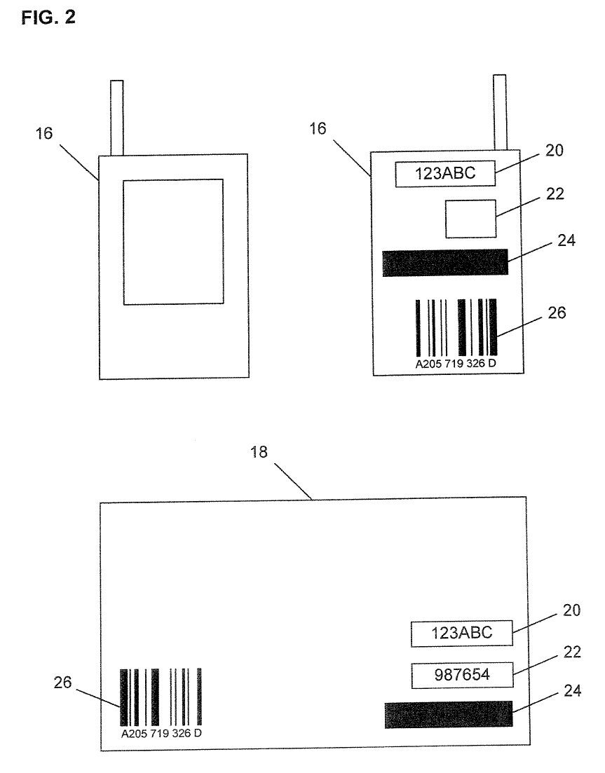

FIG. 2 illustrates an exemplary communication device 16 and package 18, the activation of which may be authorized using methods according to the invention. The top left figure in FIG. 2 shows the front view of a typical communication device 16 such as a wireless phone. The top left figure shows the rear view of a typical communication device 16.

The device 16 may have an identifier 20 associated with the device 16. The identifier 20 may be applied to (e.g., labeled on) the device 16, the package 18, or both. The identifier 20 may comprise an electronic serial number (ESN), an IMEI, a subscriber information module (SIM), a UPC code, or other number or indicia that identifies the device 16. For instance, the ESN, IMEI, and/or SIM code may comprise numbers or codes that are uniquely associated with the device 16. The identifier may be applied in a SIM card 22 (or SIM card indicia 22), a magnetic strip 24, and/or a barcode 26. For instance, the barcode 26 may represent the ESN, IMEI, or SIM, and optionally the UPC. In one embodiment, the phone has a SIM card 22 or an equivalent of a SIM card.

The identifier 20 may be visible on the outside of the device 16 and/or package 18, or it may be applied or otherwise encoded on the device 16 and/or package 18. It also may be visible only after manipulating the device 16, such as by taking out a battery. The identifier 20 may be used by the merchant, distributor, carrier, and customer to track the location and activation status of the device 16, or for any other record-keeping purpose such as inventory management.

The device 16 is typically in a package 18 prior to and during sale to a customer. The package may have barcodes and other indicia on it. The package may have an ESN 20 in barcode form. This ESN 20 may also be printed (or magnetically encoded) on the phone itself. There may be more than one identifier 20 associated with the device 16 and/or package 18. The package 18 and device 16 may also have other barcodes used during purchase or during inventory scanning or other product scanning purposes. The package 18 may have one or more identifiers that are identical to or different from the one or more identifiers 20 associated with the device. In a preferred embodiment, the device 16 and package 18 have at least one identifier 20 in common.

The bottom figure of FIG. 2 shows a package 18 configured to contain the handset 16. The package 18 may have one or more identifiers printed or otherwise stored on the package 18 as described for the handset. The package identifiers may be the same or different from the handset identifiers. In a preferred embodiment, the package 18 and device 16 have at least one identifier that is identical on both the package 18 and device 16, such as an ESN 20.

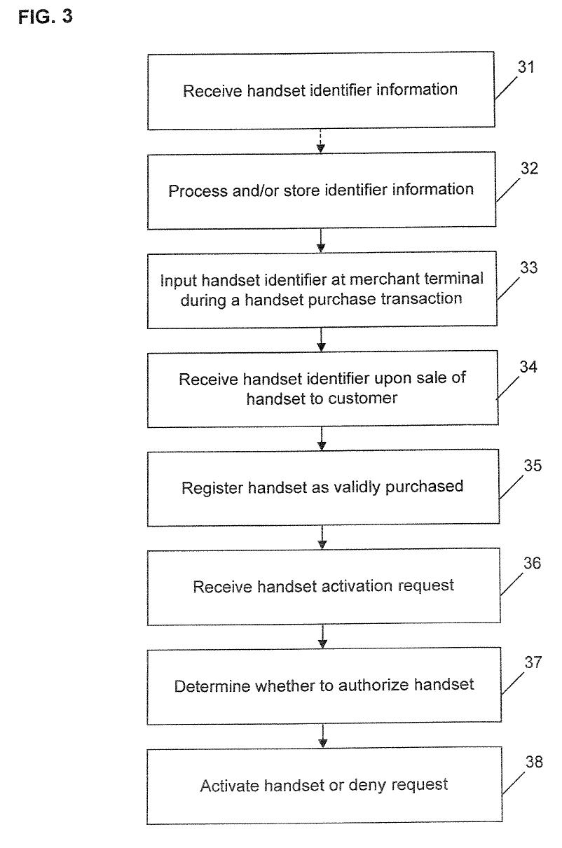

FIG. 3 illustrates a flowchart showing a method of authorizing the activation of a communication device according to an embodiment of the invention. As used herein, the term “handset” refers generally to any type of communication device regardless of whether it actually comprises a handset.

In step 31, handset identifier information is received. For instance, the central processor and/or carrier receives handset identifier information. The manufacturer (or distributor) of the handsets may pass an inventory list of handset ESNs (or other identifiers) to the central processor or carrier. Alternately, a merchant may provide a list of handset identifiers to the central processor or carrier after (or before) it receives the handsets from a distributor. The central processor will then have one or more handset identifiers that may eventually purchased from merchants.

In a preferred embodiment, each handset is pre-associated with a carrier. Thus, if the carrier receives handset identifier information, it would only receive handset identifier information for the handsets pre-associated with it. In another embodiment, a carrier is chosen and the communication device is associated therewith after purchase by the customer. In this embodiment, the carrier would not receive identifier information at this stage. In yet another embodiment, a carrier is chosen and the communication device is associated therewith prior to purchase by a customer.

In optional step 32, the identifier information is stored and/or processed. For instance, the central processor and/or carrier stores identifier information. The central processor and/or carrier may store a list of ESNs corresponding to handsets that were received by a particular store, delivered by a particular distributor, or manufactured by a particular manufacturer. The information may be stored in a central database coupled to the central processor or a carrier database coupled to the carrier. The central processor (and/or carrier) may also store status information associated with each handset. Because the handsets have not yet been sold, the central processor (and/or carrier) may store information for each handset indicating that the handset is “not sold.” Other methods of storing and/or identifying stored information may be used.

In step 33, a handset identifier is input at a merchant terminal during a handset purchase transaction. For instance, one or more handset identifiers may be input at a merchant terminal during a transaction in which a customer purchases the handset. In this step, the customer selects a handset to purchase and purchases the handset at a merchant terminal. During the sale, the handset package (or handset) is scanned at the merchant terminal. In a preferred embodiment, an ESN associated with the handset is input at the terminal by scanning the handset package. Whether the package or handset is scanned, the identifier input at the merchant terminal is uniquely associated with the handset itself.

Multiple identifiers may be input at the merchant terminal. For instance, a UPC code may be input as well as an ESN, IMEI, SIM, or other identifier. The UPC may input for merchant inventory purposes, while the ESN may be input for purposes of eventual handset activation.

It should be noted that the handset is inactive or disabled prior to delivery to the customer. For instance, the handset is hotlined or otherwise disabled in the switch. It may be actively or passively disabled. The merchant may disable the handset at (or prior to) purchase. In a preferred embodiment the handset is disabled before it is distributed to the merchant. In one embodiment, the carrier disables the handset, such as before the merchant receives the handset into merchant inventory. For instance, the SIM may be disabled. This may occur before it is offered to the customer (e.g., before the product is placed on the store shelves or otherwise offered to the customer), or it may occur during the purchase transaction. When the SIM is disabled, the handset is disabled and cannot enable wireless handset service. In order to activate the handset, the customer must later contact a central server (such as by calling an 800 number or accessing a website of the carrier) and activate the handset. The server may comprise a computer or handset system of a telecommunications provider (i.e., carrier), preferably the provider of the wireless service to be enabled on the customer's purchased handset.

In optional step 33, the merchant terminal may also input information regarding the purchaser, such as the purchasers name, address, social security number, PIN, home or other telephone number, email address, website, or other information. Some of this information may be identified via a purchaser credit card or check, or the information may be provided by the customer at the request of the merchant. Customer information may also be passed to the central processor or carrier, which may store such information in a database. This information may be used to verify the identity of the purchaser when the purchaser later activates the phone.

In step 34, the central processor receives a handset identifier. The identifier may be the identifier input in step 33. For instance, the merchant terminal may input the identifier and then pass the identifier to the central processor during sale of the handset to a customer. In a preferred embodiment, this occurs simultaneously with the sale. For instance, the sale transaction may comprise inputting the identifier information and automatically passing the information to the central processor. For instance, a barcode may be scanned during purchase, as with typical transactions, and the barcode number may be passed to the central processor.

If a customer's funds are later determined to be invalid or insufficient, or if there is any other problem with the transaction (e.g., if the phone is returned), the merchant or merchant terminal may notify the central processor of the problem at that time. The phone may then become disabled again. Appropriate records of such return transactions may be stored and passed to the carrier and central processor.

Alternately, there may be a delay between inputting the information at the merchant terminal and passing identifier information to the central processor. For instance, the merchant terminal may wait until the customer's purchase funds clear to ensure that only validly purchased handset identifiers are passed to the central processor.

Also, if a handset is stolen or damaged, or is otherwise not eligible for distribution to a customer, the central processor may amend a database entry corresponding to the handset to reflect that the handset has been “cancelled.” Such a handset may not be activated, as reflected by its “cancelled” status.

In step 35, the handset is registered as being validly purchased and/or ready for activation. For example, the phone may become enabled or activated in the switch. In a preferred embodiment, the central processor passes handset identifier information to a carrier system to indicate that the handset was validly purchased. It may pass such information via any communication device or means, such as via the internet, dedicated data line, telephone IVR, or other system.

In a preferred embodiment, the central processor transfers such information via an API so that the carrier system can easily recognize and process the information. After the carrier system processes the information, the handset is registered in the carrier's system as a validly purchased handset. For instance, the carrier may store the identifier in a carrier database file that includes identifiers for handsets that have been validly purchased. The fact that the handset is valid is apparent from the file it is stored in. Or, the carrier may amend an existing database entry corresponding to the handset to indicate that the handset has been validly sold.

Alternately, the central processor may store status information indicating that the handset is “sold and ready for activation.” It may store such information in the manner described for the carrier system, or in any manner known in the art.

In step 36, the carrier receives from a customer a request to activate the handset. In this step, a customer contacts the carrier (via phone, internet, etc.) to activate the handset. For instance, the customer may call an 800 number that accesses a carrier IVR system, or the customer may access the carrier's website. The customer may also call a carrier customer service or activation department. The customer provides identifier information to the carrier system so that the carrier system can identify the specific handset for activation. For instance, the customer may provide the ESN or SIM, such as by entering the ESN at an internet or IVR prompt. Alternately, if the customer contacts the carrier using the handset itself, the handset may automatically provide identifier information to the carrier system.

The customer may also provide customer identification information. Such identification information may comprise a customer name, address, phone number, receipt number, product number, or other number or code that may be associated with the purchased phone, purchaser, vendor, or wireless service provider. The carrier may request to verify such information prior to activation.

In step 37, the carrier determines whether the handset has been validly purchased. In a preferred embodiment, the carrier checks its database to determine whether the identifier is associated with a validly purchased handset. For instance, the carrier may determine whether an identifier associated with the handset (such as the ESN) is stored in a database corresponding to valid handsets.

In another embodiment, the carrier system contacts the central processor to determine whether the identified handset has been validly sold. For instance, the carrier system (such as a customer service center) may pass a handset identifier (such as the one provided in step 36) to the central processor. This may occur by accessing a central processor IVR system, or by any other method of communication as described herein. The central processor would receive the identifier, access its database to determine whether the identifier is associated with a validly purchased identifier, and then pass an authorization result back to the carrier. The authorization result may indicate that the phone was validly sold or that the phone was not validly sold (or that there was some other problem associated with the handset). For instance, the central processor may determine the authorization result based on stored authorization status information.

In step 38, the carrier activates the handset or denies the customer's request. If the carrier determines that the handset was validly purchased, the carrier may activate the handset. If the carrier determines that the handset was not validly purchased, or if there is some other problem with the purchase of the handset, then the carrier may deny the customer's request and refuse to activate the phone.

When a carrier activates the handset, the handset becomes usable. For instance, if the handset is a wireless telephone, then activating the handset might allow the customer to use the handset to access the carrier's wireless telecommunications services.

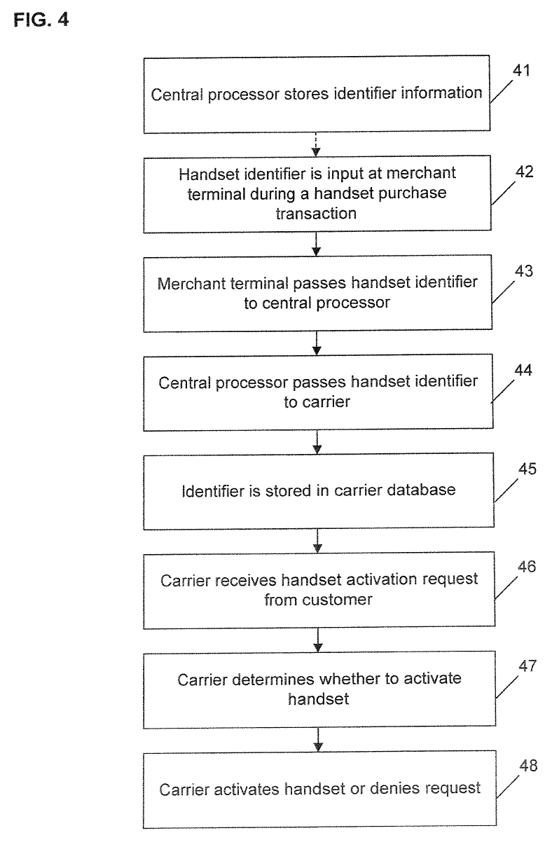

FIG. 4 illustrates a flowchart showing a method of authorizing the activation of a communication device according to another embodiment of the invention. The method of FIG. 4 should be interpreted in light of the discussion of FIG. 3.

In optional step 41, the central processor stores identifier information, e.g., as described for step 32.

In step 42, a handset identifier is input at a merchant terminal during a handset purchase transaction, e.g., as described for step 33.

In step 43, the merchant terminal passes the identifier to the central processor, e.g., as described for 34.

In step 44, the central processor passes the identifier to the carrier.

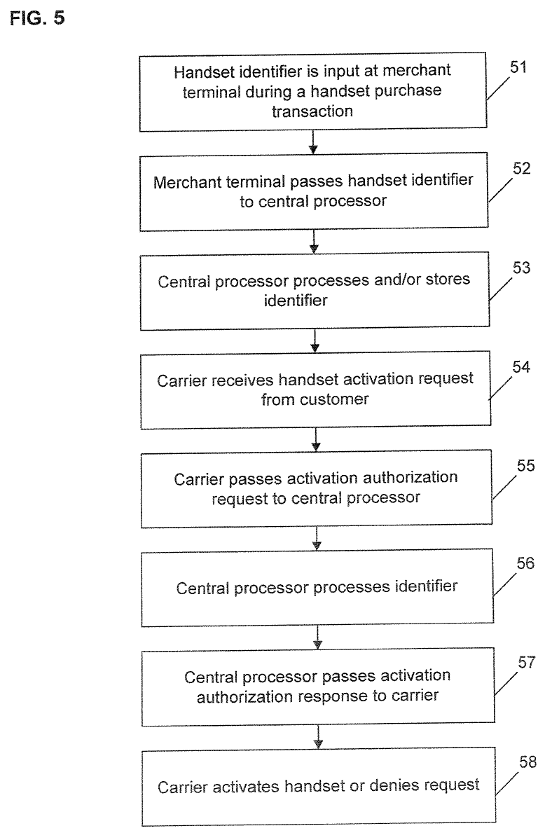

In step 45, the identifier is stored in a carrier database. A status of the identifier (and/or corresponding handset) may be stored and/or updated based on receiving the identifier from the central processor. The various status possibilities are described below with respect to FIG. 5.

Steps 44 and 45 may occur when, e.g., the central processor inserts the identifier into a carrier database, e.g., using an API. This process is also described in step 35.

In step 46, the carrier receives a handset activation request, e.g., as described for step 36.

In step 47, the carrier determines whether to activate the handset. This may comprise accessing a carrier database to determine whether the identifier is in the database, or to determine whether the identifier is associated with a handset that has been approved for activation. This may also comprise determining the status of the identifier (and/or the corresponding handset).

In step 48, the carrier responds to the customer request by either activating the handset or by denying the customer request. For instance, if the identifier is in the database (or if the identifier is associated with a handset approved for activation), the carrier will activate the handset. If not, then the carrier may deny the request.

FIG. 5 illustrates a flowchart showing a method of authorizing the activation of a communication device according to yet another embodiment of the invention. The method of FIG. 5 should be interpreted in light of the discussion of FIG. 3.

In step 51, the handset identifier is input at a merchant terminal during a handset purchase transaction, e.g., as described for step 33.

In step 52, the merchant terminal passes handset identifier information to the central processor, e.g., as described for step 43.

In step 53, the central processor processes and/or stores the identifier. For instance, the central processor may store the identifier in a database entry (or amend an existing database entry) to indicate that the identifier was received from a merchant terminal. The entry may be reflect that the corresponding handset has a particular status, e.g., that the handset is sold and ready for activation.

In step 54, the carrier receives a handset activation request from the customer, e.g., as described for step 46.

In step 55, the carrier passes the activation authorization request to the central processor.

In step 56, the central processor processes the identifier. The central processor may determine whether the identifier was validly sold. For instance, the central processor may determine whether the identifier was received in a transaction according to steps 51 and 52. The central processor may also determine the status of the handset (and/or corresponding identifier). For instance, the central processor may determine that the handset has a particular status, such as “sold and ready for activation,” “not sold,” “sold and activated,” “sold and returned,” or “cancelled.” Depending on the status, the central processor may determine to pass a positive or negative (or other) activation response. For instance, the central processor may determine to send a positive response if the corresponding handset is “sold and ready for activation.” The central processor may pass a negative response if the status is “cancelled,” “not sold,” or “sold and returned.”

In step 57, the central processor passes an activation authorization response to the carrier. The authorization response may be an indication to activate or to not activate. The authorization response may comprise status information about the identifier and/or corresponding handset.

In step 58, the carrier either activates the handset or denies the customer's request, e.g., as described for step 48. The carrier's action may be based on the central processor's response in step 57.

According to some embodiments of the present invention, the authorization of the handset may be implicit in the request for activation. In other words, in accordance with some embodiments of the present invention, a central processor may receive an authorization request from a point of sale, based upon the valid purchase of a handset. Upon receiving the authorization request, the central processor may request activation by the provider or carrier. The provider or carrier may activate the handset, and return an indication of activation to the central processor, along with information concerning the particular handset activated. This indication may include information such as the handset's telephone number, account information, and/or value associated with the handset. Upon receiving a response from the provider or carrier that the handset is activated, the central processor may return to the customer an indication that the handset is active. This indication may be in the form of a voicemail, a text message, SMS messaging, or any other type of communication. The central processor may additionally pass on all, some, or none of the additional information provided by the central processor. For example, the central processor may provide to the customer the telephone number of the handset. In another embodiment, a plurality of providers/carriers are available to furnish selection of a specific communications service provider. Thus, prior to the step of informing the communications service provider that the communication device is authorized and requesting activation of the communication device, the central processor is configured to receive a selection of a specific communications service provider from the at least one communications service provider.

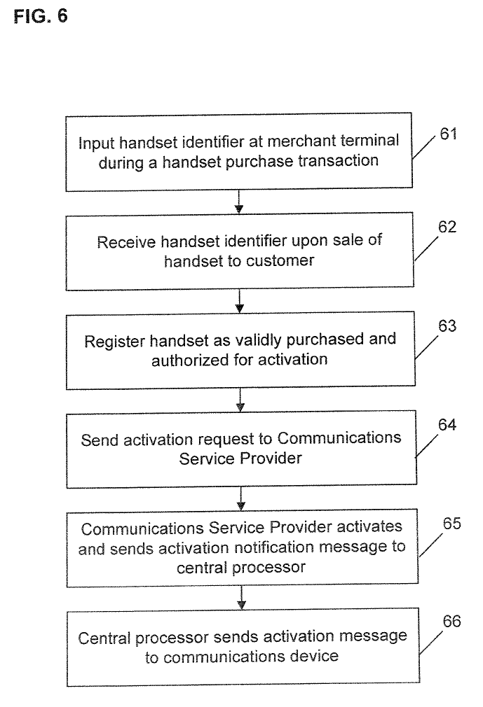

With reference to FIG. 6, a handset identifier may be input at a merchant terminal during a purchase transaction at step 61. The handset identifier may be input manually, or may be received at a point of sale system using, for example, a magnetic stripe reader or bar code scanner. At step 62 the handset identifier may be received by the central processor. At step 63, the central processor may register the handset as being a validly purchased, and therefore authorized for activation. The central processor may then request activation by sending a request to the communications service provider at step 64. The communications service provider may activate the handset, and send a notification to the central processor (step 65) which in turn may transmit the activation notification message to the handset (step 66).

In accordance with some embodiments of the present information, additional information may be captured or provided at the point of sale that may be utilized in the authorization and activation of a handset. For example, it is contemplated that when a handset is scanned at a point of sale, information identifying the handset, information identifying at least the geographic location of the point of sale, and information signifying that a valid sale has occurred may be transmitted to the central processor.

The information identifying at least the geographic location of the point of sale may include terminal, retailer, or merchant identification. This information may be transmitted in any of several ways, including but not limited to the transmission of the zip code or area code of the point of sale. The geographic location of the point of sale may then be provided by the central processor to the provider or carrier along with the activation request. The provider or carrier may use the geographic location information to determine what telephone number, including area code, the handset should be assigned.

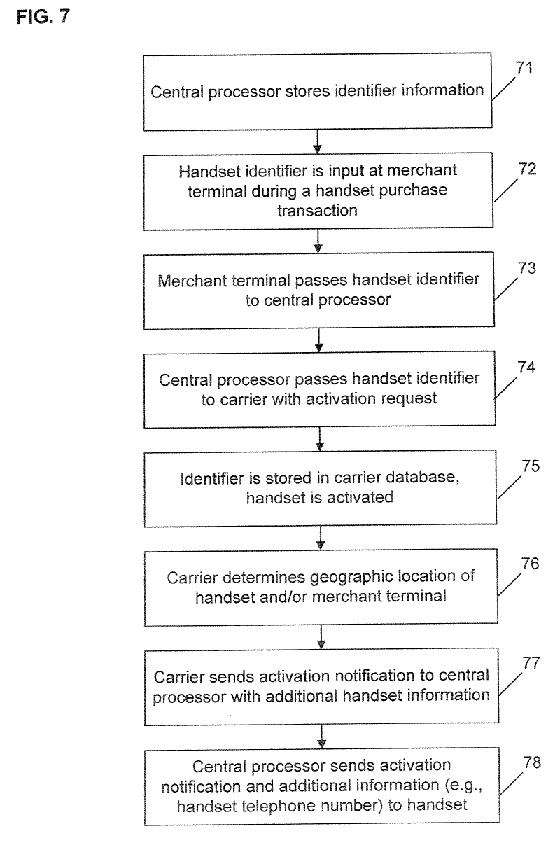

With reference to FIG. 7, the central processor may store information identifying the handset at step 71. This information may be input or received at the point of sale during a purchase transaction (step 72) and transmitted to the central processor (step 73). The central processor may verify a valid purchase transaction has taken place and authorize activation, in the form of sending an activation request to the carrier at step 74. At step 75, the identifier may be stored in the carrier database (assuming the carrier did not previously have a record of the handset). At step 76 the carrier determines the geographic location of the handset or merchant terminal. This step is performed so that the carrier can assign the proper telephone number, including area code, to the handset. At step 77 the carrier sends an activation notification to the central processor, which in turn sends it to the handset at step 78.

In accordance with some embodiments of the present invention the handsets may be available for sale with a pre-loaded activation applet. During sale, the handset may be identified and an authorization request may be sent to a central processor. The central processor may then modify its records or database entries to indicate that the specific handset was validly sold during a purchase transaction. The central processor may then either reach into the provider or carrier database and flag the specific handset as authorized, or may make its records available for a query from the provider or carrier. Following purchase, a customer may turn the handset on. The handset may then, either automatically or following customer input, run the activation applet. The activation applet may contact the provider or carrier and request activation. If the provider or carrier records reveal that the handset is authorized (e.g., by the central processor reaching in to modify the provider or carrier records), the provider or carrier may activate the handset. If the provider or carrier records do not reveal that the handset is authorized, the provider or carrier may query the central processor records to determine if the central processor has determined that the handset is authorized.

Following a determination that the handset is to be authorized, the provider or carrier identifies the geographic area of the handset. This identification may occur in many ways, including but not limited to, based on information received from the point of sale (e.g., the zip code of the point of sale where the handset was purchased), based on information received from the handset (e.g., its determined geographic location). The provider or carrier may provide this information to the central processor, which in turn may provide this information to the customer.

Additionally, it is contemplated that handsets may be sold that are not assigned to a particular provider or carrier. Upon the purchase of such a generic handset, the user may select the desired provider or carrier at the point of sale, or may select the provider or carrier during a later transaction, or prior to the transaction. If the user selects the desired provider or carrier during the purchase transaction, the selection may be transmitted to a central processor. The central processor may then inform the provider or carrier of the selection, and request that the provider or carrier activate service for the handset. The provider or carrier may then activate service, and may transmit information regarding the handset (e.g., the handset's telephone number, account number, etc.) directly to the customer via the handset, or to the central provider, which in turn may provide this information to the customer. It is also contemplated that provider or carrier selection may occur after the handset is purchased, for example by the customer visiting a particular web page or network location and identifying the provider and carrier and/or specific features about the handset or service plan desired. It is further contemplated that provider or carrier selection may occur prior to handset purchase. When the carrier or provider is selected, the communication device may then be associated with that carrier or provider.

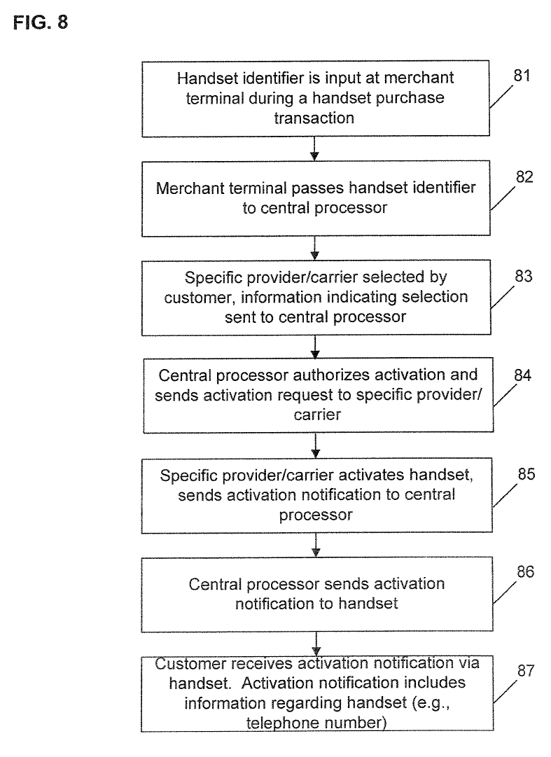

With reference to FIG. 8, the handset identifier may be input or provided at a merchant terminal during a purchase transaction at step 81. At step 82, the handset identifier may be passed to the central processor. At step 83, the customer purchasing the handset may select a specific provider/carrier to provide communication service to the handset and associate the communication device with the provider. This selection is sent to the central processor. The central processor determines that the handset was validly sold, authorizes activation, and sends an activation request to the specific provider/carrier. The specific provider/carrier may activate the handset and send an activation notification to the central processor at step 85. The central processor may in turn send this message to the handset at step 86, where it is received by the customer at step 87. In another embodiment, a plurality of providers/carriers are available to furnish selection of a specific communications service provider. Thus, prior to the step of informing the communications service provider that the communication device is authorized and requesting activation of the communication device, the central processor is configured to receive a selection of a specific communications service provider from the at least one communications service provider.

It should be noted that different identifiers may be used in the different steps described herein, provided that the different identifiers are associated with a single handset. I.e., it is not necessary that the ESN be the single identifier that is used throughout the process. For instance, a barcoded number (e.g., a number that is mapped to or otherwise associated with a SIM or ESN in a database) may be scanned at the merchant terminal and passed to the central processor, but the processor may determine the SIM or ESN and pass it to the carrier. Here, the central processor may receive the UPC and determine the ESN or SIN that is associated with that barcode by processing information stored in a database (for instance, information received from the merchant associating UPC numbers with ESN numbers). Also, it should be appreciated that the term “identifier” may comprise information associated with the identifier. In other words, an identifier received by a carrier need not be the exact same as the identifier passed from a merchant terminal to a central processor in an earlier step, provided that the two identifiers are uniquely associated with the same device.

It should also be noted that the communication devices mentioned above may be activated in any manner as described for activating PINs in the above-referenced applications.

It will be understood that the specific embodiment of the invention shown and described herein is exemplary only. Numerous variations, changes, substitutions and equivalents will now occur to those skilled in the art without departing from the spirit and scope of the present invention. Accordingly, it is intended that all subject matter described herein and shown in the accompanying drawings be regarded as illustrative only and not in a limiting sense and that the scope of the invention be solely determined by the appended claims.

What is claimed is:

1. A method of activating a communication device, comprising:
receiving at a central processor an authorization request from a merchant terminal at the merchant store to authorize activation of a communication device, the central processor being in selective communication with the merchant terminal and a communications service provider;
determining at the central processor whether the communication device was validly sold from the merchant store in a purchase transaction;
authorizing at the central processor activation of the communication device, responsive to a determination that the communication device was validly sold from the merchant store in a purchase transaction;
informing the communications service provider that the communication device is authorized and ready for activation;
receiving at the central processor an activation notification from the communications service provider; and
sending an activation notification message to the communication device.

2. The method of claim 1, wherein the activation notification message comprises a notification that the communications device has been activated and additional information.

3. The method of claim 2, wherein the additional information comprises the telephone number of the communications device.

4. The method of claim 1, wherein the activation request is from a customer.

5. The method of claim 1, wherein the activation request comprises an identifier.

6. The method of claim 5, wherein the identifier comprises at least one of an ESN, SIM, or IMEI.

7. The method of claim 1, wherein the communication device is associated with a specific communication service provider prior to sale.

8. The method of claim 1, wherein the communications device is associated with a specific communications service provider at the point of sale.

9. The method of claim 1, wherein the communications device is associated with a specific communications service provider after the purchase transaction.

10. The method of claim 1, wherein the communication device is a wireless communication device.

11. The method of claim 1, further comprising:
denying at the central processor authorization of the communication device responsive to a determination that the communication device was not validly sold in a purchase transaction.

12. The method of claim 1, wherein the step of informing the communications service provider that the communication device is authorized and ready for activation comprises sending a notification from the central processor to communications service provider.

13. The method of claim 1, wherein the step of informing the communications service provider that the communication device is authorized and ready for activation comprises the central processor reaching into the communications service provider system and modifying its records.

14. A method of activating a communication device utilizing a central processor, intermediate of a merchant terminal at a merchant store and at least one communications service provider, the method comprising:
receiving at the central processor request to activate a communication device from the merchant terminal;
determining at the central processor whether the communication device is authorized for activation;
upon a determination that the communication device is authorized for activation, informing the at least one communications service provider that the communication device is authorized and requesting activation of the communication device; and
sending an activation notification message to the communication device.

15. The method of claim 14, wherein the step of determining at the central processor whether the communication device is authorized for activation comprises determining if the communications device was validly sold from the merchant store in a purchase transaction.

16. The method of claim 15, wherein the activation notification message comprises a notification that the communications device has been activated and additional information.

17. The method of claim 16, wherein the additional information comprises the telephone number of the communications device.

18. The method of claim 15, further comprising the step receiving at the central processor an activation notification from the communications service provider prior to step of sending an activation notification message to the communication device.

19. The method of claim 15, further comprising the step of receiving a selection of a specific communications service provider from the at least one communications service provider, prior to the step of informing the communications service provider that the communication device is authorized and requesting activation of the communication device.
